(19) United States
(12) Patent Application Publication
(10) Pub. No.: US 2015/0202627 A1
(43) Pub. Date: Jul. 23, 2015

(54) APPARATUS AND METHOD FOR MOUNTING TISSUE SECTIONS ON MICROSCOPIC SLIDES

(71) Applicant: Yibing Li, San Francisco, CA (US)

(72) Inventor: Yibing Li, San Francisco, CA (US)

(21) Appl. No.: 14/591,015

(22) Filed: Jan. 7, 2015

Related U.S. Application Data
(60) Provisional application No. 61/929,983, filed on Jan. 22, 2014.

(51) Int. Cl. B01L 9/00; B01L 1/00

(52) U.S. Cl. CPC B01L 9/52; B01L 1/00; B01L 2200/028; B01L 2200/025

(57) ABSTRACT

A novel apparatus for mounting tissue sections to microscope slides and method of use are provided. Current methods of mounting tissue sections on microscope slides can be challenging for researchers, often result in torn, twisted, or creased tissue sections and are low throughput. The described novel tissue mounting apparatus provides an improved, efficient and easy-to-use tool for researchers in mounting tissue sections on microscope slides while maintaining the integrity of the tissue. The tissue mounting apparatus comprises a fluid-filled open-top chamber containing a stage specifically designed for seating a microscope slide(s) at the center on the floor of the chamber. The stage characteristically is leveled and elevated from the floor. The tissue sections can settle on a microscope slide that is submerged in the liquid inside the mounting chamber. After the tissue sections adhere to the microscope slide in the fluid filled chamber, the fluid can be removed. As a result, the mounted slide emerges from liquid phase ready for research purposes or examination.

### FIELD OF THE INVENTION

The current invention relates to a tissue section mounting apparatus and the method of use to mount tissue sections to the microscopic slide(s).

### BACKGROUND OF THE INVENTION

Many areas of medical research and life science require the examination of tissues and cellular structures under a microscope. The preparation of samples for microscopic analysis is a multistep process that begins with fresh tissues of various sources and ends in tissue sections mounted on the microscope slides that have identifiable tissue and cellular structures at the molecular and cellular levels. The complete process involves fixation, sectioning, staining, and mounting. Fixation preserves tissue structures using cross-linking reagents such as formaldehyde solutions. Section involves slicing the tissue specimen into very thin layers, i.e. sections, so that it may be examined under a microscope. In general, the thinner the tissue sections, the better the structural resolution under a microscope. But as the tissue sections are made thinner they become very delicate and easy to damage. Staining involves the use of chemical dyes, dye labeled antibodies or other molecules to mark specific tissues, cells, or subcellular structures so that they can be visualized and identified under a microscope. Mounting entails placing the thin tissue sections on the microscope slide. Before examination, the tissue sections on the slides are usually covered with preservative solutions and a glass cover slip.

Common protocols for preparing fresh specimens for microscope examinations include: paraffin-embedding (wax infiltration) of fixed tissues followed by microtome sectioning, mounting and staining; cryostat sectioning of fresh frozen tissues followed by mounting, fixation and staining; and microtome sectioning of fixed frozen tissues followed by staining and mounting.

In the aforementioned protocols, mounting the tissue sections to the microscope slides is an indispensable step. However, the mounting step is very technically challenging as well as time consuming, especially with microtome sectioning of fixed frozen tissues. FIG. 1 schematically depicts the conventional method for mounting sections to a slide in a liquid filled container. In general, a soft brush is used to grip the tissue sections and to transfer them to the microscope slide where they adhere.

In dealing with soft and delicate tissues, such as brain sections or sections from unhealthy, damaged, or injured tissues, the mounting process can be very difficult. This is because in the conventional mounting procedure, the slide is tilted to an angle and submerged with sample end in the liquid. A brush is used to drag and place the sections on the slide while smoothing off wrinkles. Due to gravity and perhaps the surface forces at the interface, the tissue sections tend to slip off from the slide when they are in contact with liquid. Therefore, one needs to hold the section in place while lifting the slide out of the liquid so that the tissue section may adhere to the slide. This maneuver may be repeated several times when placing multiple sections on one slide is desired. Typically, as the slide is gradually lifted out from the liquid, additional sections are dragged and adhered to the remaining area on the slide. This conventional method is difficult and time consuming. Often the tissue sections are torn, twisted, or creased. In addition, if multiple sections are place on one slide, the section that is placed first and the section that is last are air-dried to different degrees. The drying of tissue may alter the 3-dimensional structure of a section permanently. The difference in dryness among sections may therefore cause different degrees of structural alteration among sections and result in a decrease in the precision of measurements during microscope examination.

### DETAILED DESCRIPTION OF THE INVENTION

To improve the process of mounting tissue sections on microscope slides, a novel tissue mounting apparatus is developed. The apparatus is an open-top chamber wherein the floor of the chamber contains one or more leveled slide mounting stages fabricated specifically to support microscope slides. The mounting stage raises the slide from the floor creating an open space beneath (FIG. 2 and FIG. 3). The mounting chamber can be filled with a fluid such as phosphate-buffered saline (PBS) to cover the slide.

For a slide to sit securely, the slide mounting stage is made of four short poles, each 5 mm tall. These poles are arranged in a 25.5 by 76 mm (center to center distance) rectangle (FIG. 2). The top of each pole has a right angled indentation 1 mm deep allowing secure placement of the glass slide as illustrated in FIG. 2 and FIG. 3. In the example given in FIG. 2 and FIG. 3, the slide mounting stage is to seat only one slide. To increase the throughput, the slide mounting stage can be fabricated to seat two or more slides. For example, to seat two slides inside the chamber, the number of short poles to form the slide mounting stage can be increased from four to six to form two 25.5 by 76 mm rectangles. In this case, two poles are shared.

The tissue mounting apparatus given in FIG. 2 and FIG. 3 contains two mounting chambers. This duplex chamber configuration is practical and convenient, readily allowing transport of liquid between the two chambers. In this design, a slide and sections are placed in the first chamber filled with liquid. After sections are mounted on the slide, the liquid is transported to the second chamber and one can mount sections on slides in the second chamber without adding solution or changing labwares. Also in the model given in FIG. 2 and FIG. 3, a round bubble level of 12 mm in diameter is installed on the dividing wall between two chambers. The bubble level helps to set the apparatus as well as the slide mounting stage at a leveled position.

To operate, the apparatus is first set at a leveled position by adjusting the four leg levelers (FIG. 3 and FIG. 5). A microscope slide is placed on the mounting stage and the mounting chamber is filled with liquid, (e.g. PBS), to cover seated slide. The tissue sections are placed in the chamber. By gravity the sections sink to the floor of the chamber. Since the slide is leveled, one can place tissue sections on slide with gentle maneuvers of a brush, with which sections tend to spread evenly without stretches or twists. Since the sections are placed on the leveled surface they will not move without disturbance and one can place as many tissue sections on the slide all at once as the surface area allows (FIG. 3).

After tissue sections are placed on the slide they gradually settle, flatten, and adhere slightly on the slide surface within a few minutes, at which point fluid may start to be removed or drained from the mounting chamber. As the fluid inside chamber is removed, the movement of the fluid can create current or flow. With sufficiently slow removal, and a leveled and elevated slide, the force of the current or flow will not disturb sections on the slide

The leveled slide mounting stage is an important feature because unlike the conventional mounting step in which the slide is tilted and tissue sections tend to slip from the slide, the leveling of the slide prevents tissue sections from falling from the surface not only during the mounting step but also during fluid removal. The elevated slide mounting stage is another important feature because it reduces the disturbance from the flow or current generated during liquid removal. FIG. 4 depicts the effects of the elevated mounting stage with fluid withdrawn at the floor of the chamber. As the fluid is withdrawn, it creates equilibrating flow inside the chamber. The flow is divided into two proportions, i.e. the flow above the slide surface and the flow underneath the slide (FIG. 4). When the liquid inside the chamber is at a high level, the flow created by withdrawal is slowed above the slide surface where the tissue sections are attached (FIG. 4A). As the liquid level inside chamber decreases (FIG. 4B), the flow effect on the slide surface decreases as significant amount of flow is underneath the slide body (FIG. 4B).

### EXAMPLES

The current invention provides a novel apparatus with leveled and elevated slide mounting stage to seat a microscopic slide. To increase the throughput of the mounting process, the dimensions of the mounting chamber may be increased so that the slide mounting stage can be enlarged as well to seat two or more slides (vide supra).

After tissue sections are adhered to the slide, there are at least three different ways to fetch the mounted slide. These three examples are: withdrawing liquid manually using a pipette; draining the fluid at the center of the floor through an opening; and raising the slide mounting stage slowly and steadily above the fluid surface along with the adhered tissue sections.

The first example is a manual operating system that uses a pipette, such as a bubble pipette, to remove fluid. The detailed specifications of the apparatus are given in FIG. 2, FIG. 3 and FIG. 5. Using a bubble pipette to remove fluid near the floor of the chamber reduces the flow or current on the slide surface and minimizes the disturbance. One typical volume cycle of a bubble pipette is about 1.5 ml, and a few dozen actions will remove enough fluid from the chamber so that the mounted slide emerges above the liquid. Other pipette types could be used as well.

The second example employs a drain opening and external tubing, and at the distal end, an electric pump may be connected to the tubing to control the flow. The external tubing connects to the drain opening of the floor at the center of the chamber. FIG. 6 illustrates that a microscope slide is seated at the slide mounting stage. After the sections are mounted to the glass slide in the aqueous phase, activation of the pump drains the fluid from the chamber. In the given example, there are two mounting chambers and both are connected through tubing and electric pump. The pump transfers fluid in both directions, i.e. pumping fluid from one chamber to the other, so that while one chamber is drained the other one is filled with the fluid. Since the drain opening is at the floor on the center of the chamber (FIG. 6 and FIG. 7), the dissipating flow moves in all directions away from the center on the slide surface. The pattern of flow will cause minimum disturbance, since on the slide surface the dissipating flow moves in all directions away from the center canceling the flow effects.

The third example is to make the mounting stage raisable. In this configuration, the slide mounting stage is placed on a sliding pole which passes through the floor at the center of the chamber. The sliding pole is vertical to the leveled mounting stage. After sections are mounted, the pole may be raised up and push slowly and steadily the mounting stage as well as slide up to emerge out from the aqueous phase. The pole should be well sealed around its path at the floor of the chamber to prevent leak.

In all cases, after the slide has surfaced from the aqueous phase, residual liquid on the slide surface will need to be carefully removed without disturbing the tissue sections. This can be done using a fine tip pipette. The slide with sections attached may then be removed from the mounting stage carefully and the surface may be dried with blotting papers. Once the visible liquid is removed the sections will adhere tightly to the surface of the slide and the next steps, such as staining the sections or covering them with a cover slip may be performed.

### BRIEF DESCRIPTION OF DRAWINGS

FIG. 1 Schematic drawing depicts the conventional method for mounting tissue sections on a slide. Arrows from right to left are: (1) a deep glass jar; (2) liquid inside jar, usually PBS; (3) tissue sections; (4) a microscope slide. A fine brush is used to drag the sections on to the slide. Since the slide is tilted, the tissue section tends to slip off from the slide or stick to the slide with wrinkles or twists. If the section is from injured, unhealthy or fragile tissues this process tends to make tears in the sections.

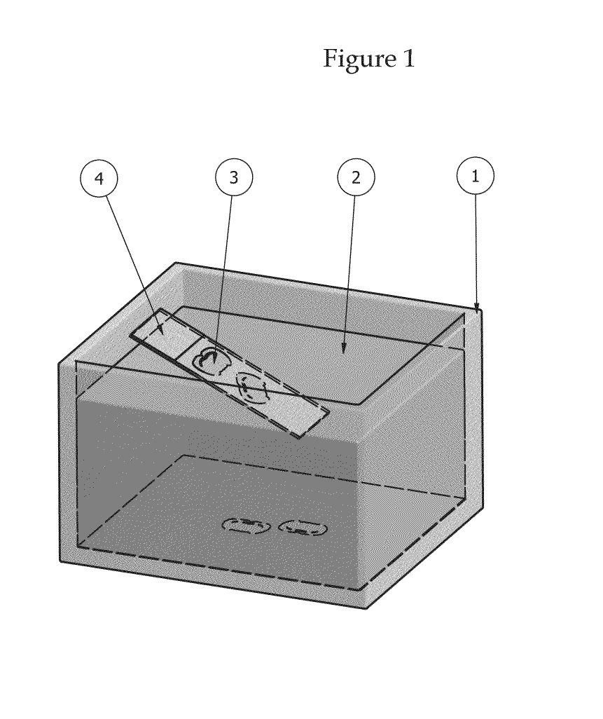

FIG. 2 Schematic drawing of the tissue mounting apparatus, i.e. example 1 (see text in the section of EXAMPLES). There are four panels and they are (from upper-left panel and clockwise) back, projected, right and top view of the apparatus. The apparatus contains two chambers and each has the inside dimensions of 92 (depth)×58 (width)×45 (height) mm. The bottom measurements are slightly smaller than the top measurements (given). The apparatus is equipped with a 12-mm diameter round bubble level on the dividing wall. There are four holes at four corners on the bottom. The holes are 2 mm in diameter and 10 mm in depth and they have internal threads to fit with the thread of leg levelers. The adjustment of leg levelers sets the apparatus to a leveled position. Inside each chamber, there are four short poles; each one is 6 mm in diameter and 5 mm in height. On the top of each pole, there is a 90° edge cut in 1.0 mm deep towards the center of the chamber. This is to fit a standard microscope slide (25.5 mm×76 mm).

FIG. 3 Schematic drawing depicts the novel tissue mounting apparatus with a slide mounted with multiple tissue sections inside the chamber. From left to right, arrows are: (1) mounting chamber; (2) liquid inside chamber; (3) microscope slide; (4) round bubble level; (5) leg levelers. The microscope slide sits inside chamber. It is much easier to place sections on the leveled slide with a brush.

FIG. 4A (top) and 4B (bottom) Schematic drawings depicting the flows inside chamber when one is removing fluid from the bottom of the chamber using a bubble pipette. From left to right: (1) arrows indicating directions of the flow; (2) a portion of a bubble pipette; (3) microscope slide; and (4) liquid inside jar. When there is plenty of liquid (4A), liquid withdrawal inside the chamber produces minimum disturbance to the sections on the glass slide. When the liquid inside the chamber is low (4B), the main flow is critically underneath the glass slide. This serves as a shunt to redirect the flow and to prevent the sections from being “washed off.”

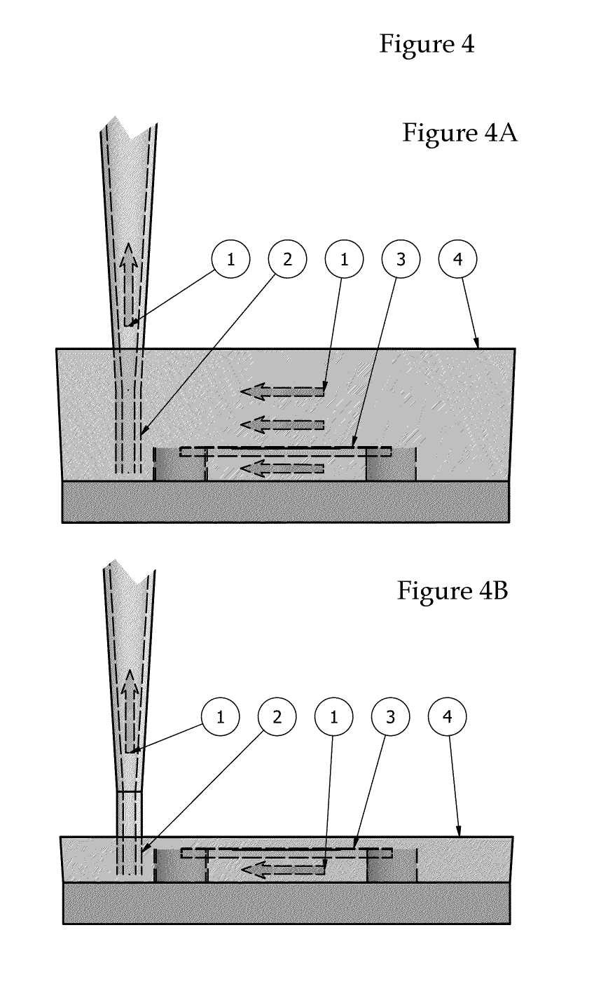

FIG. 5 The complete set of novel tissue mounting apparatus (‘manual’ and see example 1 in text). From left to right: (1) leg levelers; (2) apparatus; (3) 12-mm round bubble level; (4) 50 mm filter with nylon mesh (used to filter out any tissue debris while transferring fluid between two chambers); (5) bubble pipette; (6) fine tip brush.

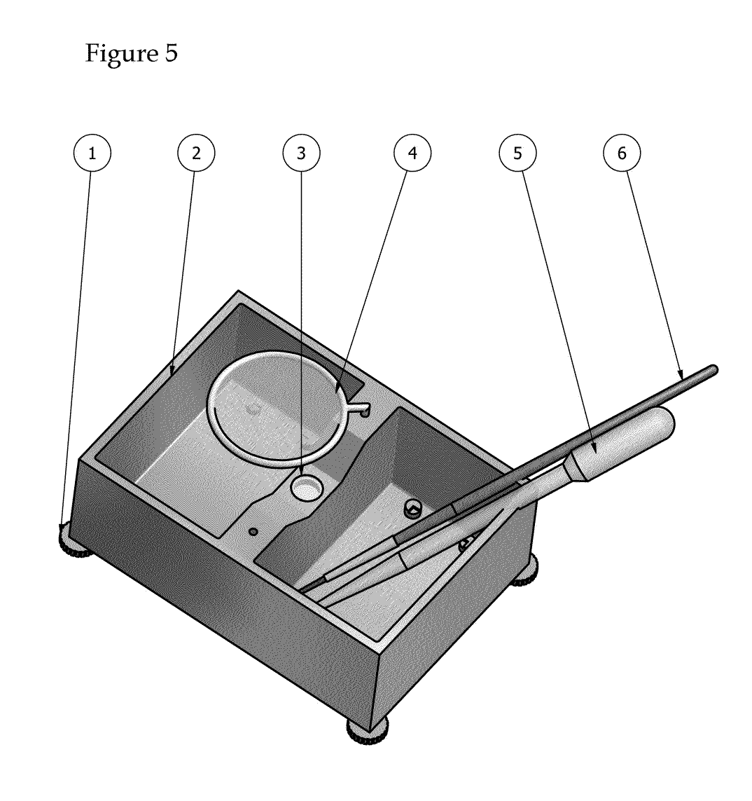

FIG. 6 Tissue section mounting apparatus example 2 that is equipped with an electric water pump. From left to right: (1) leg levelers; (2) connection tubing; (3) drain opening; (4) electric water pump; (5) 12-mm round bubble level; (5) glass slide with tissue sections attached.

FIG. 7 Schematic drawing of the slide mounting apparatus modified to adapt with an electric water pump, i.e. example 2 in the text. There are four panels and they are (from upper-left panel and clockwise) back, projected, right, and top view of the apparatus. The apparatus contains two chambers and each has the inside dimensions of 92 (depth)×58 (width)×45 (height) mm. The bottom measurements are slightly smaller than the top measurements (given). The bottom of both chambers is tilted towards the drain opening which is located at the center on the floor. Inside each chamber, there are four short poles; each one is 6 mm in diameter and 5+ mm in height. On the top of each pole, there is a 90° edge cut 1.0 mm deep towards the center of the chamber. This is to seat a standard slide (25.5 mm×76 mm). The apparatus is equipped with a 12-mm diameter round bubble level on the dividing wall. There are four holes at four corners on the bottom. The holes are 2 mm in diameter and 10 mm in depth and they have internal threads to fit with the thread on leg levelers.

What claimed is:

1. An open-top chamber comprising a stage situated at the center on the floor of the chamber wherein said stage is specifically designed to hold a microscope slide.

2. Said stage of claim 1 is leveled whereby the microscope slide sitting on the stage is also leveled.

3. Said stage of claim 1 is elevated from the floor of the chamber wherein all space below the slide is open to the flow of liquid.

4. Said stage of claim 1 can also be raised further from the floor of the chamber whereby the mounted microscope slide sitting on the stage can be raised above the aqueous phase.

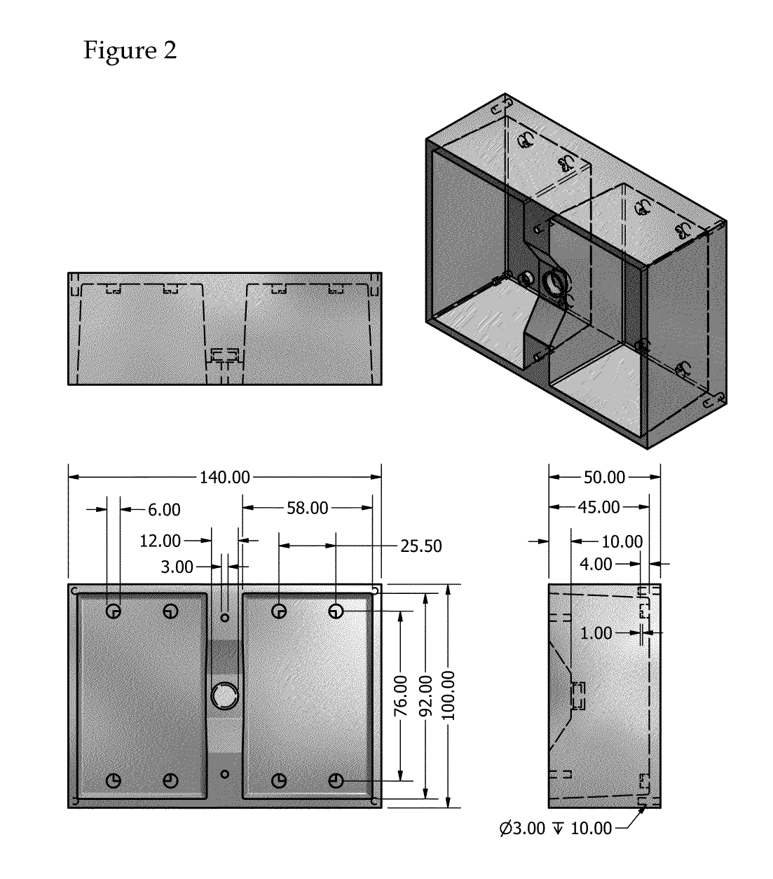

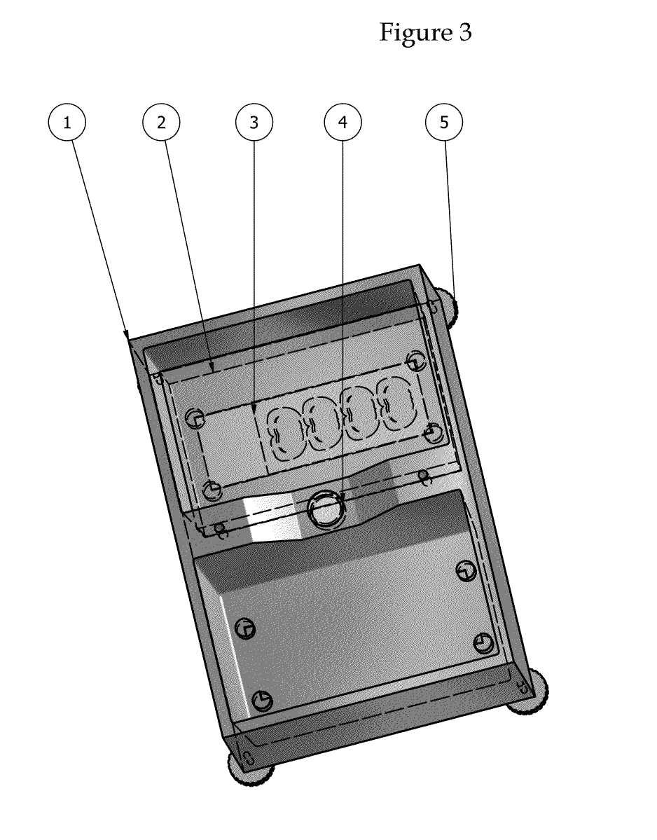

5. Said open-top chamber of claim 1 that has the featured designs as it is given in example 1 and exemplified in FIG. 2 and FIG. 3.

6. Said open-top chamber of claim 1 can also have an opening located underneath said stage of claim 1 and at the center on the floor the chamber whereby the fluid inside said open-top container of claim 1 can be drained.

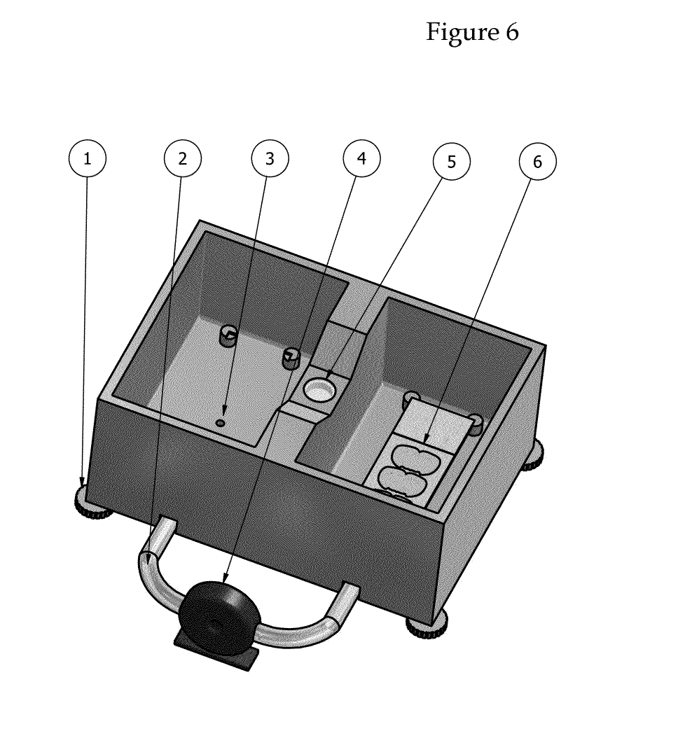

7. Said opening of claim 6 can be connected to an external pump through tubing whereby the movement of the fluid inside said open-top chamber of claim 1 can be controlled by the external pump to drain or fill the liquid inside said open-top chamber of claim 1 as it is illustrated in FIG. 6.

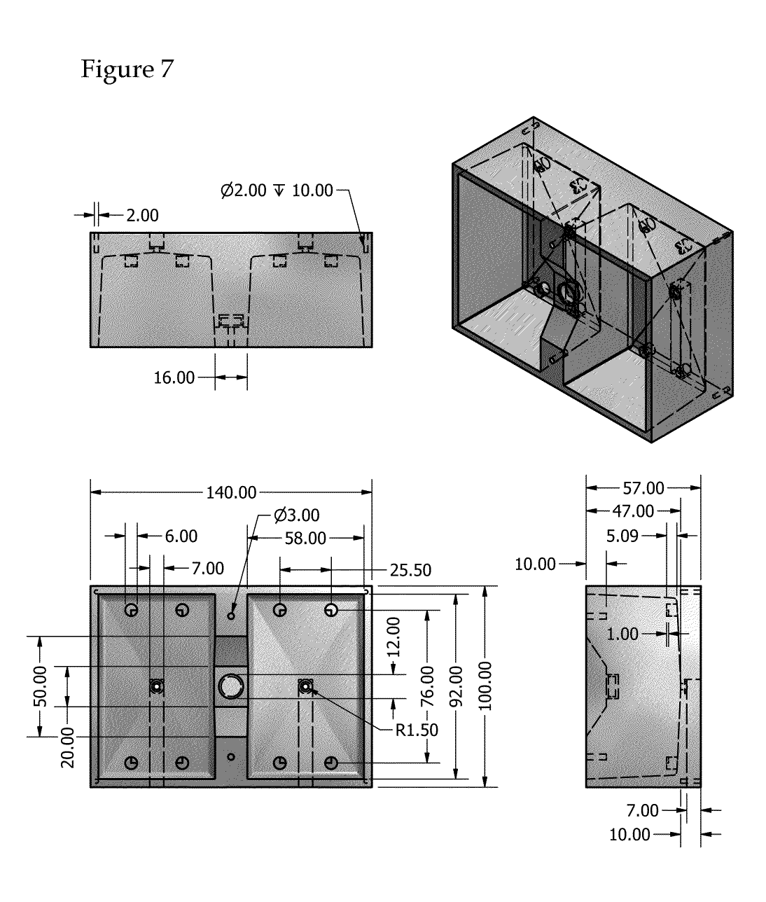

8. Said open top chamber of claim 1 that has the feature designs as it is given in example 2 and exemplified in FIG. 6 and FIG. 7.
